(19) United States
(12) Patent Application Publication
(10) Pub. No.: US 2015/0081327 A1
(43) Pub. Date: Mar. 19, 2015

(54) System and Method for Managing Appointments

(71) Applicant: Craneware plc, Edinburgh (GB)

(72) Inventor: Manjit Mooker, Glasgow (GB)

(21) Appl. No.: 14/488,580

(22) Filed: Sep. 17, 2014

(30) Foreign Application Priority Data
Sep. 17, 2013 (GB) 1316488.4

(51) Int. Cl. G06Q 10/10; H04W 4/02; G06Q 50/22

(52) U.S. Cl. CPC G06Q 10/1095; G06Q 50/22; H04W 4/025
USPC 705/2

(57) ABSTRACT

Systems and methods for managing appointments and, particularly, for managing appointments for patients in healthcare systems that include health care facilities and hospitals. Computer systems can detect geophysical positions of patient devices, such as their smart phones to update likelihood of patients being able to make appointment dates on time during the date of the appointments The computer systems can detect the patients travel locations before the appointment at one or more geo-fences associated with the location of the appointment for determining whether the geographical position is inside or outside the geo-fence to determine likelihood of patient making their appointment ontime, and if time permits registering the patient during their travels to the appointment, and/or sending reminders to the patient of the scheduled appointment time, or determining if the appointment needs to be rescheduled.

### CROSS REFERENCE TO RELATED APPLICATIONS

This application claims the benefit of priority to United Kingdom Application No. 1316488.4 filed Sep. 17, 2013, the entire disclosure of which is incorporated by reference in its' entirety.

### FIELD OF INVENTION

The present invention generally relates to systems and methods for managing appointments and, particularly, for managing appointments for patients in healthcare systems that include health care facilities and hospitals.

### BACKGROUND AND PRIOR ART

Queues, and associated waiting times, represent several issues to health care centres since they negatively impact the patient experience and make the management of patient appointments difficult to optimise. Waiting areas of health care facilities and hospitals are often increasingly smaller with no such decline in the volume of patients; this has led to often dramatic overcrowding of waiting areas and a further reduction in patient satisfaction.

Kiosk based queue management systems are common in many high throughput patient administration centres. Health care facilities and hospitals have been implementing kiosk based patient self-service for over 15 years due to the need to not only offer patients more choice in how they interact with the health care centre, but to generate cost savings and drive efficiencies. However, kiosk based self-service check-in has a number of limiting factors including: placement, maintenance, depreciation, infection control and utilisation which in turn can have adverse cost implications.

Moreover, there are many instances of, so called, DNAs (Did Not Arrive or Did Not Attend) in health care facilities and hospitals. That is, an appointment for a patient has been made; however, for unknown reasons, the patient has not actually arrived at the health care facilities and hospitals for the appointment. Kiosk based systems only alert the health care system when a patient has actually turned up and, therefore, do not provide any real solutions to such DNA instances.

A further limitation of kiosk based systems is that the process of creation, acceptance and/or rejection of appointment times is not adequately addressed either.

The present invention ameliorates or mitigates the limitations of present appointment management systems and methods and provides other benefits as will become clearer to those skilled in the art from the foregoing description.

### SUMMARY OF THE INVENTION

A primary objective of the present invention is to provide systems and methods for retrieving from a data store data associated with at least one appointment, the data including at least the attendee, the location of the appointment and the time of the appointment.

A secondary objective of the present invention is to provide systems and methods for communicating with a device associated with the attendee in order to obtain the geographical position of the device.

A third objective of the present invention is to provide systems and methods that based on the obtained geographical position of the device and the time remaining until the time of the appointment, perform one or more actions associated with the appointment and, if required, updating the data store accordingly.

The appointment management system and method of the present invention provides a direct way to engage with appointment attendees (“patients”) through the use of the attendee's cellular mobile telephone or smartphone. The system and method include the provision of an application (“app”) for a smartphone which interacts with a server to provide substantially real-time information on the geographical position of the attendee in relation to the geographical position of the appointment center, such as the health care facilities and the hospital.

The system and method can be enabled to assess the likelihood of the attendee not attending their appointment based on predetermined metrics.

Furthermore, the system and method can be enabled to send automatic reminders of the appointment, or other functions, such as enabling check-in for the appointment, based on both time and/or distance from the health care facilities and the hospital.

In addition, the system and method handles the provisioning of appointments through messages direct to the smartphone. Acceptance and/or rejection of appointments are therefore handled more quickly than traditional methods, such as letter or email, and with reduced administrative overheads. In this regard, it should be noted that, if an appointment is rejected more quickly, then it is able to be marked as free for other potential appointments more quickly, thereby increasing utilisation and reducing overall waiting times.

For those without smartphones, the system and method are also enabled to send and receive messages via short message service (SMS) text messages and via automated interactive telephone systems.

Accordingly, the system and method manages appointments before the attendee has even arrived at the appointment health care facilities and hospitals, and reduces both waiting times for patients and the impact of attendees that do not arrive for their appointment.

Further objects and advantages of this invention will be apparent from the following detailed description of the presently preferred embodiments which are illustrated schematically in the accompanying drawings, and in the appended claims.

### BRIEF DESCRIPTION OF THE FIGURES

Preferred embodiments of the invention will now be described, by way of non-limiting examples only, with reference to the accompanying drawings, in which:

FIG. 1 shows a schematic diagram of a system for managing appointments according to one aspect of the present invention;

FIG. 2 shows a flow diagram illustrating a process of logging in to a client application;

FIG. 3 shows a flow diagram illustrating a geo-fencing decision process;

FIG. 4 shows a schematic diagram of a system for managing appointments according to one aspect of the invention showing example hardware and communications; and

FIG. 5 shows a kiosk and stand which provides an alternative interface or may be used when a mobile client application is not available.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

A preferred embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

A typical embodiment of the present invention will include a data store, or data store access, including appointment details, a communications link capable of connecting to the internet, a central processor and, via the internet communications link, one or more client applications installed on attendee devices. The processor performs the tasks of accessing and, where required, storing details of appointments, according to pre-defined time periods, requesting data from the one or more client applications relating to upcoming appointments and, particularly, where an appointment is within a pre-defined time period, requesting the geographic location of the attendee device, and performing one or more actions based on the location of the attendee device.

A list of components will now be described.
10 data store
12 processor
14 central computer system
16 internet/worldwide web
18A, 18b attendee's devices
20 communications links
22A, 22B distances
30 authenticating attendees
32 login step
34 authentication step
38 authentication step
40 PIN request step
42 access to system step
54 geographica position retrieval step
56 negative results step
58 positive results step
60 appointment management system
62 internal security area
64 private security area
66 public security area
68 patient administration system(PAS)
70 location and check in server
72 kiosk
74 clinical access point
76 front end check in server
78 patient or attendees' devices
80 internet
82 internet firewall
84 communications link
86 Virtual Private Network (VPN) link
90 kiosk system
92 kiosk
94 stand

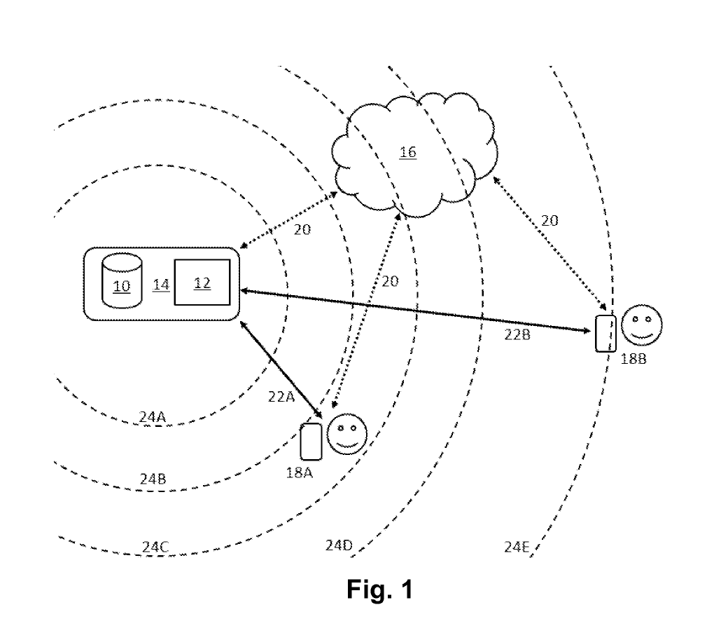

With reference to FIG. 1, in a preferred embodiment of the invention, a data store 10 and a processor 12 are shown as part of a central computer system 14. The data store 10 may comprise multiple data stores as required by the central computer system 14 and the processor 12 may comprise multiple processors as required by the central computer system 14. The data store 10 may be implemented through a database system, which may be distributed amongst multiple computers. The Internet 16 serves as a communication link for the computer system 14. The computer system 14 can communicate with client applications installed on attendees's devices 18A, 18B via communications links 20 to the internet 16. Whist the “internet” is specifically described within this example, it possible for the system to operate on any suitably configured network system. The central computer system 14, communications links 20 and attendee's devices 18A, 18B having client applications together constitute one embodiment of a system for managing appointments.

In operation, the computer system 14 accesses appointment details from the data store 10. Where an appointment is due within a pre-defined time scale, such as any time that day, the appointment details are retrieved. The appointment details include, at least, the time of the appointment, the appointment attendee, whether the attendee has installed and registered the client application etc. Separately, or additionally, data is retrieved to ascertain whether the client application of the attendee is in communication with the system. If the client application is in communication with the system, data is requested from the client application including the geographical position of the attendee at the time of the request.

The computer system 14 also has access to the geographical position of the physical centre at which the appointment is taking place and one or more pre-defined “geo-fences”. A “geo-fence” being a pre-defined geographical boundary, or series of boundaries, which may be defined, for example, as a radius from a point or by a series of absolute or relative latitude and longitude positions. A distance can be calculated between the geographical position of the attendee, or, more specifically, the attendee's device, and the geographical position of the appointment centre. In the example shown in FIG. 1, the two separate attendee's devices 18A and 18B are calculated to be at distances 22A and 22B from the appointment centre, respectively. Alternatively, the geographical position is simply determined as being inside or outside the geo-fence to allow appropriate action to then be taken.

Either at regular intervals or at specified times relative to the appointment time, the computer system 14 receives the geographical position of the attendee's device, either by instigation of the client application, or on request from the computer system 14, and compares that received position with the time remaining until the scheduled appointment and the pre-defined geo-fences. Based on that comparison one or more actions are taken as described below.

For example, it may be that a geo-fence has been defined a certain distance from the appointment centre and a check is made an hour before the scheduled appointment time in order to ascertain whether the attendee is inside the geo-fence, with respect to the appointment centre. If the attendee is determined to be inside the geo-fence, then the appointment centre's computer systems (which may be the computer system 14 or a separate computer system) are updated to show that the attendee is predicted to be on time. If the attendee is outside the geo-fence, the appointment centre's computer systems are updated to show that the attendee may not attend the appointment (in other words the system predicts a ‘Did Not Arrive/Attend) risk). In either instance, the computer system 14 may also communicate with client applications installed on the attendee's devices 18A, 18B to show a reminder regarding the scheduled appointment time and/or requesting that they contact the centre.

Further geographical checks may be scheduled as a result of the geographical position check regarding the attendees. For example, if the attendee is outside the geo-fence in the example above, a follow-up geographical enquiry may be scheduled e.g. 45 minutes prior to the scheduled appointment time and then again, 30 minutes prior to the scheduled appointment time.

When a geographical check indicates that the attendee is within a pre-defined geo-fence that is near to the appointment centre, the client application is enabled to allow the attendee to check-in for the appointment. This allows appointment specific or attendee specific information to be collected prior to the actual appointment and avoids the attendee having to register their attendance at a reception desk, or similar, thereby providing time savings for both the attendee and reception staff.

The appointment management system of the present invention also allows messages and general communications to be sent to the client applications installed on attendee's devices 18A, 18B independent of geographical location. For example, the appointment management system can also handle the setting of an appointment. If an appointment has been requested for a potential attendee who has already installed a client application on their device, the proposed appointment time and location can be communicated with the client application. The client application then displays the appointment time and location to the potential attendee who can then choose to accept or reject the proposed appointment. If the appointment is rejected, then this immediately frees that appointment time on an appointment schedule in the appointment management system for use by other attendees. If the patient cannot accept the appointment, the client application can provide an option to “Request Alternative”. If “Request Alternative” is selected, then the patient selects a number of alternative dates and time which are then transmitted back to the hospital booking team who can then reissue a date which fits the patients' availability. This further mitigates the risk of DNA, since the patient has played a part in booking their appointment.

Appointments are traditionally, at least in a health care environment, sent out by mail to the attendee. If the appointment is not suitable, the delay before that appointment slot becomes free again is considerable. Therefore using the client application, the appointment management system sends the proposed appointment time directly to the attendee and a fast, or at least faster, response can be expected than traditional methods.

In the system described above, a client application must be installed on a device that the attendee controls. With the advent of more powerful cellular mobile telephones, or smartphones, as well as other devices, such as tablets, the ‘app’, or application, market has become large. As such, it is common for the general public to have a smartphone and access to an appropriate app market, such as iTunes® or Google Play®. Therefore, the client application on the attendee's device 18A, 18B is preferably an ‘app’ on a smartphone. Smartphones commonly have access to position information either from cellular signal data, wi-fi data or GPS data. As such, the client applications installed on the attendee's devices 18A, 18B will request access to the available position information from any or all of these sources. In addition, as the client application is preferably downloaded from an application market, the attendee will be required to register or authenticate their identity to enable the computer system 14 to differentiate different attendees from one another.

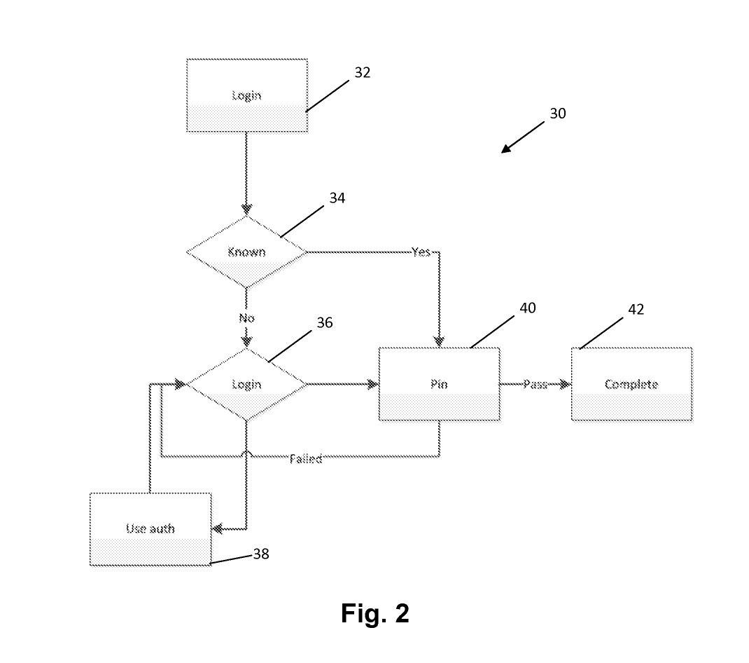

Referring to FIG. 2, a method of authenticating attendees 30 is shown in which the attendee firstly attempts to login at step 32. If the attendee has not previously been authenticated, as checked at step 34, then detailed login details are requested at step 36 from the attendee. The detailed login details may be, for example, in the form of a registration identification number or other identification number, or they may be a number or personal details or both, as required by the appointment management system. In this example, a Personal Identification Number or PIN is included in the personal details for use later. Alternatively, where the client application is installed on a device, such as a smartphone, and the like, as required by the appointment management system. Once the detailed login details have been entered the user is then authenticated at step 38. The authentication step preferably takes the form of the client application communicating some or all of the detailed login details with the computer system 14 in order to authenticate those details against details already held on the computer system 14. Once the attendee has been authenticated, the system then requests the attendees PIN at step 40 before allowing access to the system at step 42. If the attendee has been previously authenticated, as confirmed at step 34, then the method of authenticating attendees 30 simply requests the previously set-up PIN number (step 40) to allow access to the system (step 42). The method of authenticating attendees is the preferred login method that can be used by the system and method of managing appointments as described herein.

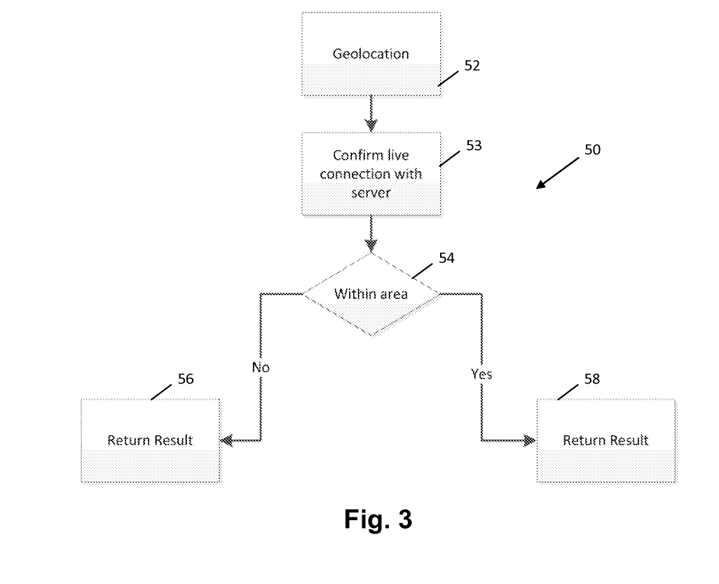

Referring now to FIG. 3, a method of geolocation 52 is shown. As described above in relation to FIG. 1, the method and system for managing appointments includes a geographical position check, also known as geolocation. One method of performing that geolocation is shown in the method of FIG. 3. Firstly, the geographical position of a particular attendee is either requested from the computer system 14 or scheduled, or otherwise initiated, to be transmitted to the computer system 14 by the client application 18A, 18B at step 52, or by the smartphone.

At step 53, the client application confirms that a live connection or communication channel is available to the computer system 14. Subsequently, in step 54, that geographical position is received by the computer system 14 and identified as whether it is within a ‘geo-fence’ (as described above), also known as a geographical area. If the position is not within the geo-fence, then a negative result (step 56) is returned and one or more or actions are performed as a result. If the position is within the geo-fence, then a positive result (step 58) is returned and one or more actions are performed as a result.

One or more actions, can be performed if the client is not in the geo-fence position. The actions can include but are not limited to: the patient cannot check in for their appointment, a distance monitor will be still presented to the hospital staff telling them the patient is X distance away, and the like.

If the patient does not make it within their allocated time slot, the patient will not be allowed to check in even if they are within the location. If the patient misses their appointment, the patient can also register as a DNA patient. If the first patient does not make it within their allocated time slot, all other patients in the queue who already have checked in can be seen sooner. This process can be managed automatically via the application software.

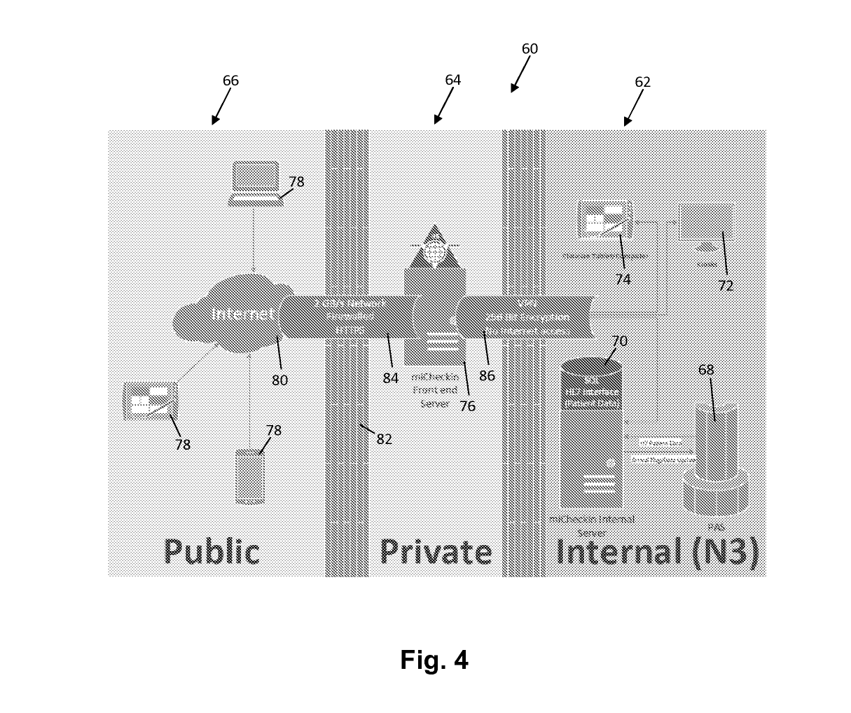

Referring now to FIG. 4, one embodiment of an appointment management system 60 is shown in more detail. This particular appointment management system is a healthcare appointment management system where the attendees of the appointments are patients. The management system 60 includes three distinct security areas in the form of an internal security area 62, a private security area 64 and a public security area 66. Within the internal security area 62, the management system 60 includes a Patient Administration System (PAS) 68, a location and check-in server 70, a kiosk 72 and a clinician access point 74. Within the private security area 64 the management system 60 includes a front end check in server 76 and within the public security area 66 the management system 60 includes a plurality of attendee, or patient, devices 78. In comparison to the appointment management system 60 as described in relation to FIG. 1, the internal security area 62 and private security area 64 would be included in the computer system 14.

The patient devices 78 can communicate with the rest of the appointment management system 60 through a connection to the internet 80, preferably using SSL (Secure Socket Layer) or Transport Layer Security (TLS) encryption (HTTPS protocol). The private security area 64 is behind an internet firewall 82 but otherwise provides the front end check in server 76 with the ability to communicate through communications link 84 with the patient devices 78.

The private security area 64 and the internal security area 62 are connected via a Virtual Private Network (VPN) link 86.

As can be understood from the description of FIG. 1, the appointment management system 60 of FIG. 4 is able to manage the appointments of patients who have authenticated their client applications, on devices 78, with the management system 60. Importantly, the geographical position of the devices 78 can then be derived and used to manage actions to the patients' device 78 and, where required, other systems, such as the clinicians access point 74, the kiosk 72 or the PAS 68.

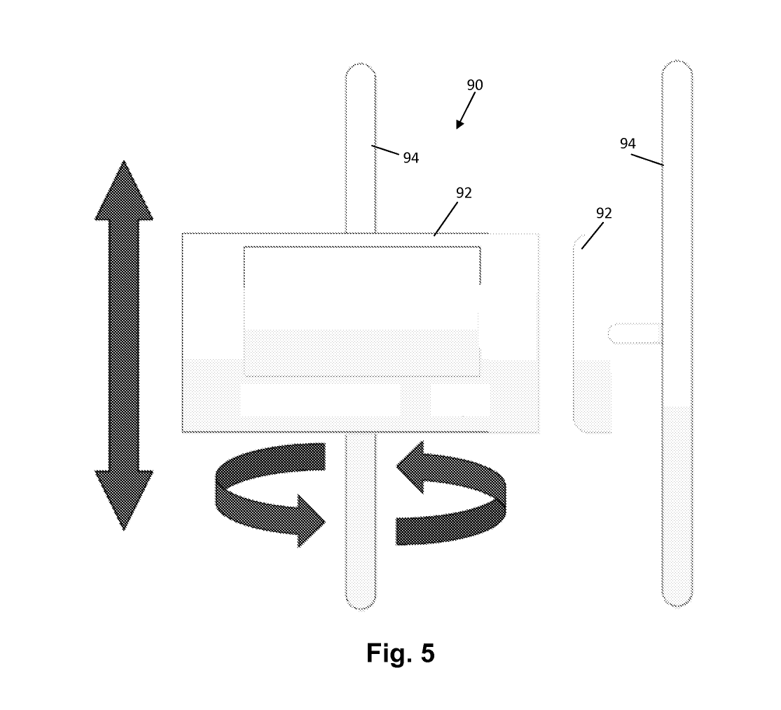

Referring now to FIG. 5, a kiosk system 90, which can be used with the appointment management system and method, as described above, is shown. The kiosk system 90 includes a kiosk 92 and stand 94. The kiosk 92 is connected to the stand 94 in such a manner that the kiosk 92 can be moved up and down the stand 94 and rotated to the left or right. Being able to adjust the kiosk 92 on the stand 94 allows for use of the kiosk by attendees with different physical requirements.

The kiosk 92, as described above, can be included in the appointment management system described above, to allow for attendees who have either not registered with the system, do not have a device capable of installing a client application, or do not have their device on their person at that time. However, minimising the use of the kiosk can help minimise the chances of infection and increases the overall efficiency of the system. An example of “way finding” will now be described.

Upon arrival at the building, traditionally the patient will follow signs on sign posts or by asking staff members for directions on how to get to a specific location. By using the application's “Way Finding” feature on their personal device, the patient can be directed to the exact location they are supposed to be using step by step guidance. i.e. “follow the corridor down to the end”, “Turn Left”, “Turn Right”). The directions can be done by text, voice, combinations thereof, and the like.

The “Way Finding” feature uses smart sequencing where the routes that have been created are generated dynamically based on where the patient is and where they need to be. On occasion, the patient maybe requested to attend an alternative location when they enter the building which maybe different to where the Way Finding would normally take them. The smart sequencing would dynamically generate the route based on the end point and present the route instructions to the patient. Once the patient has visited the initial location they will then be guided from point B to point C with a new set of instructions based upon know where the patient is based on the last known location and then guiding them to the next location.

An additional feature can include “way finding” which can be a non GPS (global position satellite) dependent piece of code which can direct individuals from point to point within a building. This navigation feature can enable the patient to get from point A to point B to point N all using a smart sequencing feature which has been developed for the miCheckin application. This feature can be configured by the customer as well as the programmer of the application.

Although the reminders as referenced as notifications, other uses of the notifications can be used.

Modifications and improvements may be made without departing from the scope of the present invention.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. A method for managing appointments comprising the steps of:
retrieving from a data store data associated with at least one appointment, including an attendee, a location and time of an appointment;
communicating with a device associated with the attendee to obtain the geographical position of the device;
based on the geographical position of the device and the time to the appointment, performing one or more actions associated with the appointment and,
updating the data store accordingly.

2. The method as claimed in claim 1, further comprising the step of:
retrieving data associated with one or more geo-fences associated with the location of the appointment, and
determining whether the geographical position is inside or outside the geo-fence for the step of performing the one or more actions.

3. The method as claimed in claim 1, wherein the geographical position is provided by the device at pre-defined times at either the appointment time or at specific absolute times triggered by other conditions.

4. The method as claimed in claim 1, wherein the one or more actions are selected from the group consisting of: updating the estimated time of arrival of the attendee, updating the likelihood of whether the attendee will attend the appointment, providing a reminder on the device of the appointment, requesting an estimated time of arrival from the attendee on the device, enabling the device to allow the attendee to check-in to the appointment when the geographical position is within a pre-determined geo-fence, and updating other attendees of the appointment as to the likelihood of whether the attendee will attend the appointment.

5. The method as claimed in claim 1, wherein a client application is installed on the device being a smartphone and the client application is an application installable on to the smartphone.

6. The method as claimed in claim 1, further comprising the step of:
sending to the device an appointment time and location.

7. The method as claimed in claim 6, further comprising the step of:
enabling the device to allow acceptance or rejection of the appointment time and location.

8. The method as claimed in claim 7, further comprising the step of:
choosing alternative appointment times or dates when the appointment time and location is rejected.

9. The method as claimed in claim 1, further comprising the step of:
directing navigation between different point locations by sequencing contacts with the device to follow the different point locations, wherein the method allows for a patient to get from one point to another point.

10. A system for managing appointments comprising:
a data store including data associated with at least one appointment, including an attendee, a location of the appointment and a time of the appointment;
a device associated with the attendee having the ability to obtain a geographical position of the device;
a computer processor, which is in communication with the data store, programmed to receive the geographical position of the device, and based on the geographical position and the time to the appointment, perform one or more actions associated with the appointment and, updating the data store accordingly; and
a communications link to allow communication between the computer processor and the device.

11. The system as claimed in claim 10, wherein the data store includes data associated with one or more geo-fences associated with the location of the appointment, and the computer processor calculates whether the geographical position is inside or outside the geo-fence and performs actions accordingly.

12. The system as claimed in claim 10, wherein the geographical position is provided by the device at anyone of: pre-defined times relative to the appointment time, at specific absolute times, triggered by other conditions or or is requested by the processor at pre-defined times.

13. The system as claimed in claim 10, wherein the one or more actions are selected from the group consisting of: updating the estimated time of arrival of the attendee, updating the likelihood of whether the attendee will attend the appointment, providing a reminder on the device of the appointment, requesting an estimated time of arrival from the attendee on the device, enabling the device to allow the attendee to check-in to the appointment when the geographical position is within a pre-determined geo-fence, and updating other attendees of the appointment as to the likelihood of whether the attendee will attend the appointment.

14. The system as claimed in claim 10, wherein a client application is installed on the device where the device is a smartphone and the client application is an application installable on to the smartphone.

15. The system as claimed in claim 10, wherein the processor based on information provided by the data store, is enabled to send to the device an appointment time and location.

16. The system as claimed in claim 15, wherein the device is enabled to allow acceptance or rejection of the appointment time and location.

17. The system as claimed in claim 16, wherein rejection of the appointment time provides for the attendee choosing alternative appointment times and dates.

18. The system as claimed in claim 10, wherein the devices direct the attendee to navigate between different locations.
